(19) United States
(12) Patent Application Publication
(10) Pub. No.: US 2024/0037579 A1
(43) Pub. Date: Feb. 1, 2024

(54) DEEP LEARNING SYSTEMS AND METHODS FOR PREDICTING IMPACT OF CARDHOLDER BEHAVIOR BASED ON PAYMENT EVENTS

(71) Applicant: Mastercard International Incorporated, Purchase, NY (US)

(72) Inventors: Bradley Stankey, Dallas, TX (US); S. Jordan Berman, New York, NY (US); Guofeng Li, Mclean, VA (US); Sen Yang, Arlington, VA (US)

(73) Assignee: Mastercard International Incorporated, Purchase, NY (US)

(21) Appl. No.: 17/877,598

(22) Filed: Jul. 29, 2022

(51) Int. Cl. G06Q 30/02; G06N 3/08; G06N 3/04

(52) U.S. Cl. CPC G06Q 30/0202; G06N 3/08; G06N 3/0454

(57) ABSTRACT

A system is configured to retrieve historical raw transaction data, wherein each transaction is one of a target or non-target transaction. The target transactions are related to a target transaction event. A target transaction identifier is appended to each target transaction. The raw transaction data is stored to a first data table. A first neural network is trained using the first data table to generate a training data classification model. The training data classification model is applied to the first data table. A first similarity score distribution associated with the target transactions and a second similarity score distribution associated with the non-target transactions is determined. A plurality of non-target transactions whose combined similarity score distribution matches the target transactions is selected. The target transactions and the selected plurality of non-target transactions are stored to a second data table and a second neural network is trained using the second data table.

### RELATED APPLICATIONS

The present application is filed contemporaneously with U.S. patent application Ser. No. __/______, entitled DEEP LEARNING SYSTEMS AND METHODS FOR PREDICTING IMPACT OF CARDHOLDER BEHAVIOR BASED ON PAYMENT EVENTS. The entire disclosure of the aforementioned contemporaneously filed application is hereby incorporated herein by reference.

### FIELD OF THE DISCLOSURE

The field of the disclosure relates generally to artificial intelligence and, more particularly, to systems and methods for training and applying deep learning within a payment network to predict the impact of select transaction events on cardholder behavior.

### BACKGROUND

Payment card issuers (e.g., banks) of all sizes require sufficient cash flow in order to meet their business obligations. Cash comes into an issuer (cash inflows), for example, from fee income that they charge for their products and services that include wealth management advice, checking account fees, overdraft fees, ATM fees, interest, and fees on credit cards. However, some issuers may experience unpredictable changes to their cash inflow due to various transaction events associated with their cardholders. For example, when a cardholder experiences a declined transaction, he or she may reduce the number of transactions they perform and/or reduce the amount of their transactions (e.g., making smaller transactions). Furthermore, in some instances, certain transaction events may result in an increase in cash flow to the issuer. However, it is often difficult for issuers to assess the potential impact that these transaction events may have on their revenues.

The field of artificial intelligence (AI) includes systems and methods that allow a computer to interpret external data, “learn” from that data, and apply that knowledge to a particular end. One tool of AI, inspired by biological neural networks, is artificial neural networks. An artificial neural network (or just “neural network,” for simplicity) is a computer representation of a network of nodes (or artificial neurons) and connections between those nodes that, once the neural network is “trained,” can be used for predictive modeling. Neural networks typically have an input layer of nodes representing some set of inputs, one or more interior (“hidden”) layers of nodes, and an output layer representing one or more outputs of the network. Each node in the interior layers is typically fully connected to the nodes in the layer before and the layer after by edges, with the input layer of nodes being connected only to the first interior layer, and with the output layer of nodes being connected only to the last interior layer. The nodes of a neural network represent artificial neurons and the edges represent a connection between two neurons.

Further, each node may store a value representative of some embodiment of information, and each edge may have an associated weight generally representing a strength of connection between the two nodes. Neural networks are typically trained with a body of labeled training data, where each set of inputs in the training data set is associated with known output value (the label for those inputs). For example, during training, a set of inputs (e.g., several input values, as defined by the number of nodes in the input layer) may be applied to the neural network to generate an output (e.g., several output values, as defined by the number of nodes in the output layer). This output is unlikely to match the given label for that set of inputs since the neural network is not yet configured. As such, the output is then compared to the label to determine differences between each of the output values and each of the label values. These differences are then back-propagated through the network, changing the weights of the edges and the values of the hidden nodes, such that the network will better conform to the known training data. This process may be repeated many thousands of time or more, based on the body of training data, configuring the network to better predict particular outputs given particular inputs. As such, the neural network becomes a “mesh” of information embodied by the nodes and the edges, an information network that, when given an input, generates a predictive output.

Accordingly, a deep learning system is needed for identifying and mitigating potentially detrimental effects of certain adverse transaction events on the revenues of issuers, while assisting issuers in identifying opportunities to increase their revenue stream based on the potential occurrence of certain favorable transaction events.

### BRIEF DESCRIPTION OF THE DISCLOSURE

This brief description is provided to introduce a selection of concepts in a simplified form that are further described in the detailed description below. This brief description is not intended to identify key features or essential features of the claimed subject matter, nor is it intended to be used to limit the scope of the claimed subject matter. Other aspects and advantages of the present disclosure will be apparent from the following detailed description of the embodiments and the accompanying figures.

In one aspect, a system for training and applying deep learning within a payment network to predict the impact of select transaction events on cardholder behavior is provided. The system includes a database storing historical raw transaction data, a processor, and a memory. The memory stores computer-executable instructions thereon. The computer-executable instructions, when executed by the processor, cause the processor to retrieve, via a communications module, the historical raw transaction data. The historical raw transaction data includes a plurality of transactions. Each transaction is associated with a respective cardholder account and is one of a target transaction or a non-target transaction. The processor is configured to enrich, via a data preparation engine, the historical raw transaction data by appending a target transaction identifier to each of the target transactions contained in the historical raw transaction data. The target transactions are related to a predetermined target transaction event. The processor is further configured to store the enriched first portion of the historical raw transaction data to a first data table. The processor trains, via a modeling engine, a first neural network using the first data table with the target transaction event as the dependent variable to generate a training data classification model. The processor is configured to apply, via a model application engine, the training data classification model to the first data table; determine, via the model application engine, a first similarity score distribution associated with the target transactions and a second similarity score distribution associated with the non-target transactions; and select, via the data preparation engine, a plurality of non-target transactions whose combined similarity score distribution matches the first similarity score distribution of the target transactions. Based on the selection, the processor stores the target transactions and the selected plurality of non-target transactions to a second data table. The processor is also configured to train, via the modeling engine, a second neural network using the second data table.

In another aspect, a computer-implemented method is provided. The method includes retrieving, via a communications module, historical raw transaction data from a database. The historical raw transaction data includes a plurality of transactions. Each transaction is associated with a respective cardholder account and is one of a target transaction or a non-target transaction. The method also includes enriching, via a data preparation engine, the historical raw transaction data by appending a target transaction identifier to each of the target transactions contained in the historical raw transaction data. The target transactions are related to a predetermined target transaction event. Furthermore, the method includes storing, in the database, the enriched first portion of the historical raw transaction data to a first data table. The method also includes training, via a modeling engine, a first neural network using the first data table with the target transaction event as the dependent variable to generate a training data classification model. Furthermore, the method includes applying, via a model application engine, the training data classification model to the first data table. The method includes determining, via the model application engine, a first similarity score distribution associated with the target transactions and a second similarity score distribution associated with the non-target transactions. Moreover, the method includes selecting, via the data preparation engine, a plurality of non-target transactions whose combined similarity score distribution matches the first similarity score distribution of the target transactions. Based on the selection, the method includes storing the target transactions and the selected plurality of non-target transactions to a second data table, and training, via the modeling engine, a second neural network using the second data table.

In yet another aspect, a computer-readable storage medium is provided. The computer-readable storage medium has computer-executable instructions stored thereon. The computer-executable instructions, when executed by a processor, cause the processor to retrieve, via a communications module, historical raw transaction data. The historical raw transaction data includes a plurality of transactions. Each transaction is associated with a respective cardholder account and is one of a target transaction or a non-target transaction. The computer-executable instructions further cause the processor to enrich, via a data preparation engine, the historical raw transaction data by appending a target transaction identifier to each of the target transactions contained in the historical raw transaction data. The target transactions are related to a predetermined target transaction event. Furthermore, the computer-executable instructions cause the processor to store the enriched first portion of the historical raw transaction data to a first data table, and train, via a modeling engine, a first neural network using the first data table with the target transaction event as the dependent variable to generate a training data classification model. In addition, the computer-executable instructions cause the processor to apply, via a model application engine, the training data classification model to the first data table; determine, via the model application engine, a first similarity score distribution associated with the target transactions and a second similarity score distribution associated with the non-target transactions; and select, via the data preparation engine, a plurality of non-target transactions whose combined similarity score distribution matches the first similarity score distribution of the target transactions. In addition, the computer-executable instructions cause the processor to, based on the selection, store the target transactions and the selected plurality of non-target transactions to a second data table. Moreover, the computer-executable instructions cause the processor to train, via the modeling engine, a second neural network using the second data table.

A variety of additional aspects will be set forth in the detailed description that follows. These aspects can relate to individual features and to combinations of features. Advantages of these and other aspects will become more apparent to those skilled in the art from the following description of the exemplary embodiments which have been shown and described by way of illustration. As will be realized, the present aspects described herein may be capable of other and various aspects, and their details are capable of modification in various respects. Accordingly, the figures and description are to be regarded as illustrative in nature and not as restrictive.

### BRIEF DESCRIPTION OF THE DRAWINGS

The figures described below depict various aspects of systems and methods disclosed therein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 is a schematic of an exemplary computing system for training and applying deep learning models to predict the impact of select transaction events on cardholder behavior, according to one aspect of the present invent;

FIG. 2 is an example configuration of a computing system, such as the computing system shown in FIG. 1;

FIG. 3 is an example configuration of a server system, such as the server system shown in FIG. 1;

FIG. 4 is a component diagram of a deep learning device, such as the deep learning device shown in FIG. 1;

FIG. 5 is a flowchart illustrating an exemplary computer-implemented method of training a neural network to predict the impact of select transaction events on cardholder behavior, according to one aspect of the present invention; and

FIG. 6 is a flowchart illustrating an exemplary computer-implemented method of applying deep learning to predict the impact of select transaction events on cardholder behavior, according to one aspect of the present invention.

Unless otherwise indicated, the figures provided herein are meant to illustrate features of embodiments of this disclosure. These features are believed to be applicable in a wide variety of systems comprising one or more embodiments of this disclosure. As such, the figures are not meant to include all conventional features known by those of ordinary skill in the art to be required for the practice of the embodiments disclosed herein.

### DETAILED DESCRIPTION OF THE DISCLOSURE

The following detailed description of embodiments of the invention references the accompanying figures. The embodiments are intended to describe aspects of the invention in sufficient detail to enable those with ordinary skill in the art to practice the invention. The embodiments of the invention are illustrated by way of example and not by way of limitation. Other embodiments may be utilized, and changes may be made without departing from the scope of the claims. The following description is, therefore, not limiting. The scope of the present invention is defined only by the appended claims, along with the full scope of equivalents to which such claims are entitled.

As used herein, the term “database” includes either a body of data, a relational database management system (RDBMS), or both. As used herein, a database includes, for example, and without limitation, a collection of data including hierarchical databases, relational databases, flat file databases, object-relational databases, object oriented databases, and any other structured collection of records or data that is stored in a computer system. Examples of RDBMS's include, for example, and without limitation, Oracle® Database (Oracle is a registered trademark of Oracle Corporation, Redwood Shores, Calif.), MySQL, IBM® DB2 (IBM is a registered trademark of International Business Machines Corporation, Armonk, N.Y.), Microsoft® SQL Server (Microsoft is a registered trademark of Microsoft Corporation, Redmond, Wash.), Sybase® (Sybase is a registered trademark of Sybase, Dublin, Calif.), and PostgreSQL® (PostgreSQL is a registered trademark of PostgreSQL Community Association of Canada, Toronto, Canada). However, any database may be used that enables the systems and methods to operate as described herein.

As used herein, the phrase “machine learning” includes statistical techniques to give computer systems the ability to “learn” (e.g., progressively improve performance on a specific task) with data, without being explicitly programmed for that specific task. The phrases “neural network” (NN) and “artificial neural network” (ANN), used interchangeably herein, refer to a type of machine learning in which a network of nodes and edges is constructed that can be used to predict a set of outputs given a set of inputs.

### Exemplary System

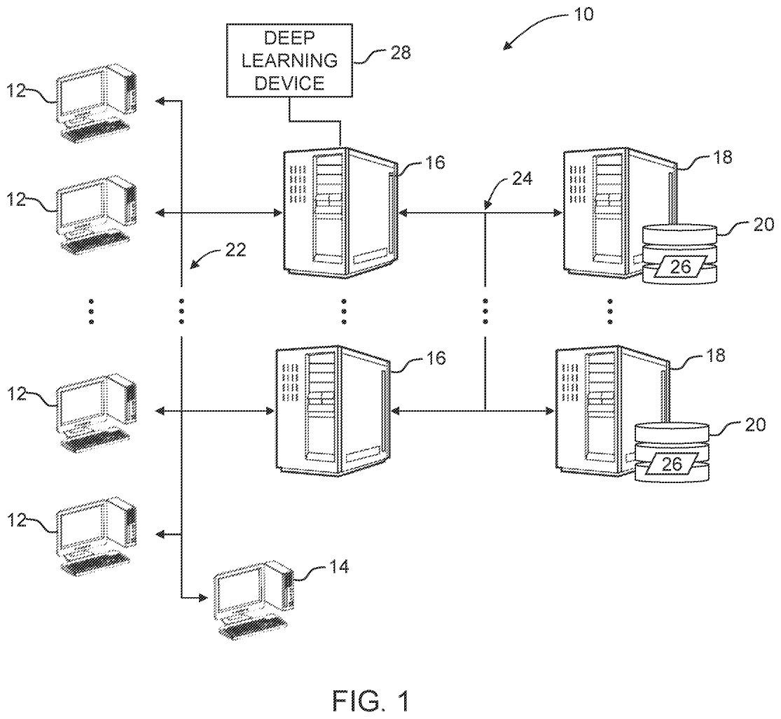

FIG. 1 is a schematic of an exemplary computing system 10 for training and applying deep learning models to predict the impact of select transaction events on cardholder behavior, according to one aspect of the present invention. In some embodiments, the computing system 10 may be a multi-party payment processing system or network, or an interchange network (e.g., a payment processor such as Mastercard®). Embodiments described herein may relate to a payment card system, such as a credit card payment system using the Mastercard® interchange network. The Mastercard® interchange network is a set of proprietary communications standards promulgated by Mastercard International Incorporated® for the exchange of financial transaction data and the settlement of funds between financial institutions that are members of Mastercard International Incorporated®. (Mastercard is a registered trademark of Mastercard International Incorporated located in Purchase, N.Y.).

In the example embodiment, the computing system 10 includes one or more computing devices 12 and 14; one or more application servers 16; one or more database servers 18, each electronically interfaced to one or more respective databases 20 (broadly, data sources); at least one deep learning device 28; and one or more communication networks, such as networks 22 and 24. In an example embodiment, one or more of the computing devices 12, 14, the application servers 16, and the deep learning device 28 may be located within network boundaries (e.g., the network 22) of an organization, such as a business, a corporation, a government agency and/or office, a university, or the like. The communication network 24 and the database servers 18 may be located remote and/or external to the organization. In some embodiments, the database servers 18 may be provided by third-party data vendors managing the databases 20. It is noted that the location of the computing devices 12 and 14, the application servers 16, the database servers 18, the deep learning device 28, and the databases 20 can all be located in a single organization or separated, in any desirable and/or selected configuration or grouping, across more than one organization (e.g., a third-party vendor). For example, in an example embodiment, the computing devices 12 can be remote computing devices, each associated with a customer, electronically interfaced in communication to the application servers 16 and the deep learning device 28, which may be located within an organization. In addition, the database servers 18 and associated databases 20 can be located within the same organization or a separate organization. While depicted as separate networks, the communication networks 22 and 24 can include a single network system, such as the Internet.

In the exemplary embodiment, the computing devices 12, 14, the application servers 16, and the deep learning device 28 are electronically interfaced in communication via the communication network 22. The communications network 22 includes, for example and without limitation, one or more of a local area network (LAN), a wide area network (WAN) (e.g., the Internet, etc.), a mobile network, a virtual network, and/or any other suitable private and/or public communications network that facilitates communication among the computing devices 12, 14, the application servers 16, and the deep learning device 28. In addition, the communication network 22 is wired, wireless, or combinations thereof, and includes various components such as modems, gateways, switches, routers, hubs, access points, repeaters, towers, and the like. In some embodiments, the communications network 22 includes more than one type of network, such as a private network provided between the computing device 14 and the application servers 16 the deep learning device 28, and, separately, the public Internet, which facilitates communication between the computing devices 12 and the application servers 16 the deep learning device 28.

In one embodiment, the computing devices 12, 14 and the application servers 16 control access to the deep learning device 28 and the database servers 18 and/or databases 20 under an authentication framework. For example, a user of a computing device 12, 14, may be required to complete an authentication process to query the databases 20 via the applications servers 16 and/or database servers 18. As described above, in some embodiments, one or more of the computing devices 12, 14 may not be internal to the organization, but may be granted access to perform one or more queries via the authentication framework. One of ordinary skill will appreciate that the application servers 16 may be free of, and/or subject to different protocol(s) of, the authentication framework.

In the exemplary embodiment, the application servers 16 and the database servers 18/databases 20 are electronically interfaced in communication via the communication network 24. The communications network 24 also includes, for example and without limitation, one or more of a local area network (LAN), a wide area network (WAN) (e.g., the Internet, etc.), a mobile network, a virtual network, and/or any other suitable private and/or public communications network that facilitates communication among the application servers 16 and the database servers 18/databases 20. In addition, the communication network 24 is wired, wireless, or combinations thereof, and includes various components such as modems, gateways, switches, routers, hubs, access points, repeaters, towers, and the like. In some embodiments, the communications network 24 includes more than one type of network, such as a private network provided between the database servers 18 and the databases 20, and, separately, the public Internet, which facilitates communication between the application servers 16 and the database servers 18.

In the exemplary embodiment, the communication network 24 generally facilitates communication between the application servers 16 and the database servers 18. In addition, the communication network 24 may also generally facilitate communication between the computing devices 12 and/or 14 and the application servers 16, for example in conjunction with the authentication framework discussed above and/or secure transmission protocol(s). The communication network 22 generally facilitates communication between the computing devices 12, 14 and the application servers 16. The communication network 22 may also generally facilitate communication between the application servers 16 and the database servers 18.

In the exemplary embodiment, the computing devices 12, 14 include, for example, workstations, as described below. The computing device 14 is operated by, for example, a developer and/or administrator (not shown). The developer builds applications at the computing device 14 for deployment, for example, to the computing devices 12 and/or the application servers 16. The applications are used by users at the computing devices 12, for example, to query data and/or generate data predictions based on the data stored in the databases 20. The administrator defines access rights at the computing device 14 for provisioning user queries to the databases 20 via the applications. In an example embodiment, the same individual performs developer and administrator tasks.

In the exemplary embodiment, each of the databases 20 preferably includes a network disk array (a storage area network (SAN)) capable of hosting large volumes of data. Each database 20 also preferably supports high speed disk striping and distributed queries/updates. It is also preferable that support for redundant array of inexpensive disks (RAID) and hot pluggable small computer system interface (SCSI) drives is provided. In one example embodiment, the databases 20 are not integrated with the database servers 18 to avoid, for example, potential performance bottlenecks.

Data persisted or stored in the databases 20 includes, for example, raw transaction data 26, such as payment transaction data associated with electronic payments. Raw transaction data 26 includes, for example, a plurality of data objects including, for example, customer transaction data and/or other transaction related data, such as cardholder account data, merchant data, customer data, etc., that can be used to develop intelligence information about individual cardholders, certain types or groups of cardholders, transactions, marketing programs, and the like. Each of the data objects comprising the raw transaction data 26 is associated with one or more data parameters. The data parameters facilitate identifying and categorizing the raw transaction data 26 and include, for example, and without limitation, data type, size, date created, date modified, and the like. Raw transaction data 26 informs users, for example, of the computing devices 12, and facilitates enabling the users to improve operational efficiencies, products and/or services, customer marketing, customer retention, risk reduction, and/or the like.

For example, in one embodiment, the application servers 16 are maintained by a payment network, and an authenticated employee of a business organization, such as an account issuer, accesses, for example, the deep learning device 28 via a data prediction application implemented on the application servers 16. The deep learning device 28 is configured to generate predictions of consumer behavior based on the occurrence or hypothetical occurrence of a selected transaction event. For example, in an embodiment, the deep learning device 28 obtains customer transaction data from the databases 20 and uses the data to identify or infer select transaction events and predict future cardholder behavior based on occurrence of the transaction event. An employee of the payment network may also access the application servers 16 from a computing device 12 or 14, for example, to query the databases 20, perform maintenance activities, and/or install or update applications, predictions models, and the like. It is noted that in some embodiments, where a cardholder's personally identifying information (PII) may be included in the customer transaction data, the deep learning device 28 obtains cardholder consent to access such transaction data. This allows cardholders control over consent-based data processing, thereby enabling cardholders to make informed decisions when deciding whether to provide consent to access the cardholder's transaction data.

In an example embodiment, the deep learning device 28 is communicatively coupled with the application servers 16. The deep learning device 28 can access the application servers 16 to store and access data and to communicate with the client computing device 12 or 14 through the application servers 16. In some embodiments, the deep learning device 28 may be associated with or part of an interchange network, or in communication with a payment network, as described above. In other embodiments, the deep learning device 28 is associated with a third party and is in electronic communication with the payment network.

The deep learning device 28, in the example embodiment, accesses historical payment transaction information or data of cardholder accounts and merchants from the database servers 18 and databases 20. Transaction information or data may include products or services purchased by cardholders, dates of purchases, merchants associated with the purchases (i.e., a “selling merchant”), category information (e.g., product category, MCC code to which the transacting merchant belongs, etc.), geographic information (e.g., where the transaction occurred, location of the merchant or the POS device, such as country, state, city, zip code, longitude, latitude), channel information (e.g., which shopping channel the transaction used, online, in store, etc.), and the like. In some embodiments, the deep learning device 28 may access consumer identity information for cardholders or item information for merchants. Such information presents high dimensional sparse features that may be used as inputs of embedding.

In the example embodiment, the deep learning device 28 uses the transaction information to train and apply deep learning techniques to predict cardholder behavior after the occurrence of certain selected transaction events (e.g., first contactless transaction, mobile transaction, cross-border transaction, declined transactions, card-on-file transactions, etc.). During configuration, the deep learning device 28 performs one or more model training methods to construct (e.g., train) one or more models (not shown in FIG. 1) using a body of training data constructed from aspects of the transaction information or data. Once constructed, the deep learning device 28 uses the model(s) to predict, for particular cardholders (e.g., cardholders being considered as targets), future transaction behavior based on the occurrence of a selected transaction event. Using that output, the deep learning device 28 may, for example, identify a set of target cardholders to receive offers or incentives from an issuer of the target cardholder's account. In some embodiments, the models may be exported to scoring, prediction, or recommendation services and integration points. Model servicing services may be integrated into business pipelines, such as embedding model use into offline systems, streaming jobs, or real-time dialogues. For example, the models may be used to identify a set of target cardholders to receive offers from a particular product category, identify a set of target cardholders to receive offers from a particular geography (e.g., zip code, city), and the like. One of ordinary skill will appreciate that embodiments may serve a wide variety of organizations and/or rely on a wide variety of data within the scope of the present invention.

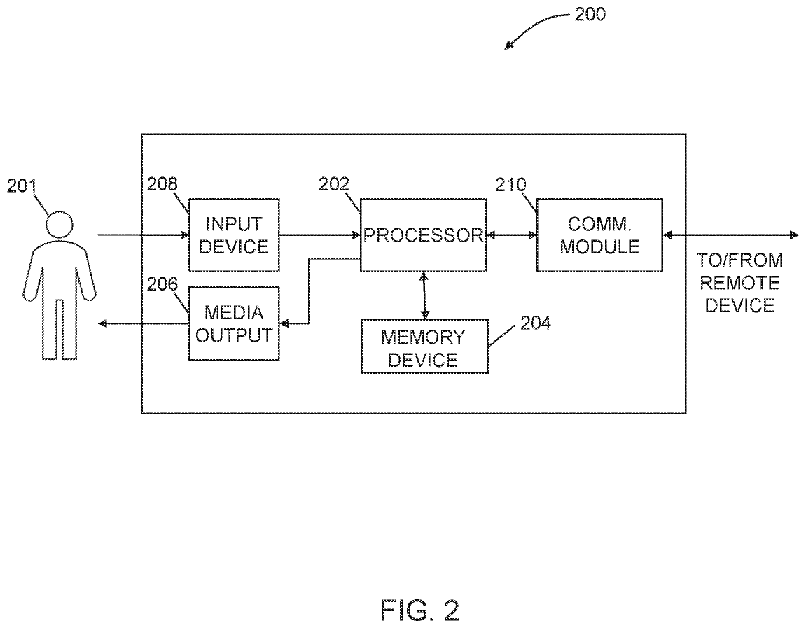

FIG. 2 is an example configuration of a computing system 200 operated by a user 201. In some embodiments, the computing system 200 is a computing device 12 and/or 14 (shown in FIG. 1). In the example embodiment, the computing system 200 includes a processor 202 for executing instructions. In some embodiments, executable instructions are stored in a memory device 204. The processor 202 includes one or more processing units, such as, a multi-core processor configuration. The memory device 204 is any device allowing information such as executable instructions and/or written works to be stored and retrieved. The memory device 204 includes one or more computer readable media.

In one example embodiment, the processor 202 is implemented as one or more cryptographic processors. A cryptographic processor may include, for example, dedicated circuitry and hardware such as one or more cryptographic arithmetic logic units (not shown) that are optimized to perform computationally intensive cryptographic functions. A cryptographic processor may be a dedicated microprocessor for conducting cryptographic operations, embedded in a packaging with multiple physical security measures, which facilitate providing a degree of tamper resistance. A cryptographic processor facilitates providing a tamper-proof boot and/or operating environment, and persistent and volatile storage encryption to facilitate secure, encrypted transactions, data transmission/sharing, etc.

Because the computing system 200 may be widely deployed, it may be impractical to manually update software for each computing system 200. Therefore, the computing system 10 may, in some embodiments, provide a mechanism for automatically updating the software on the computing system 200. For example, an updating mechanism may be used to automatically update any number of components and their drivers, both network and non-network components, including system level (OS) software components. In some embodiments, the computing system components are dynamically loadable and unloadable; thus, they may be replaced in operation without having to reboot the OS.

The computing system 200 also includes at least one media output component 206 for presenting information to the user 201. The media output component 206 is any component capable of conveying information to the user 201. In some embodiments, the media output component 206 includes an output adapter such as a video adapter and/or an audio adapter. An output adapter is operatively coupled to the processor 202 and operatively connectable to an output device such as a display device, for example, and without limitation, a liquid crystal display (LCD), organic light emitting diode (OLED) display, or “electronic ink” display, or an audio output device such as a speaker or headphones.

In some embodiments, the computing system 200 includes an input device 208 for receiving input from the user 201. The input device 208 may include, for example, one or more of a touch sensitive panel, a touch pad, a touch screen, a stylus, a position detector, a keyboard, a pointing device, a mouse, and an audio input device. A single component such as a touch screen may function as both an output device of the media output component 206 and the input device 208.

The computing system 200 may also include a communication module 210, which is communicatively connectable to a remote device such as the application servers 16 (shown in FIG. 1) via wires, such as electrical cables or fiber optic cables, or wirelessly, such as radio frequency (RF) communication. The communication module 210 may include, for example, a wired or wireless network adapter or a wireless data transceiver for use with Bluetooth communication, RF communication, near field communication (NFC), and/or with a mobile phone network, Global System for Mobile communications (GSM), 3G, or other mobile data network, and/or Worldwide Interoperability for Microwave Access (WiMax) and the like.

Stored in the memory device 204 are, for example, computer readable instructions for providing a user interface to the user 201 via the media output component 206 and, optionally, receiving and processing input from the input device 208. A user interface may include, among other possibilities, a web browser and a client application. Web browsers enable users, such as the user 201, to display and interact with media and other information typically embedded on a web page or a website available from the application servers 16. A client application allows the user 201 to interact with a server application associated, for example, with the application servers 16.

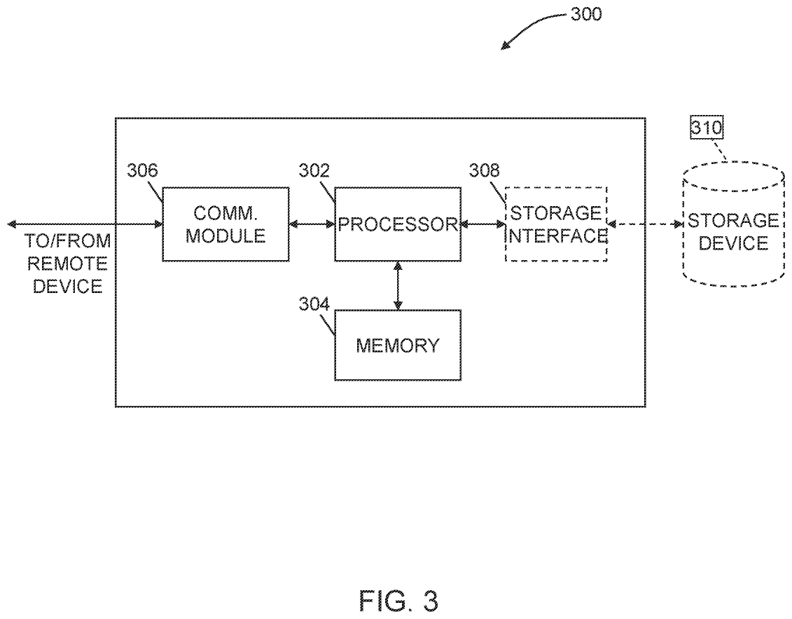

FIG. 3 is an example configuration of a server system 300. The server system 300 includes, but is not limited to, the application servers 16 (shown in FIG. 1) and the database servers 18 (shown in FIG. 1). In the example embodiment, the server system 300 includes a processor 302 for executing instructions. The instructions may be stored in a memory area 304, for example. The processor 302 includes one or more processing units (e.g., in a multi-core configuration) for executing the instructions. The instructions may be executed within a variety of different operating systems on the server system 300, such as UNIX, LINUX, Microsoft Windows®, etc. More specifically, the instructions may cause various data manipulations on data stored in a storage device 310 (e.g., create, read, update, and delete procedures). It should also be appreciated that upon initiation of a computer-based method, various instructions may be executed during initialization. Some operations may be required to perform one or more processes described herein, while other operations may be more general and/or specific to a programming language (e.g., C, C#, C++, Java, or other suitable programming languages, etc.). In the example embodiment, the processor 302 may be implemented as one or more cryptographic processors, as described above with respect to the computing system 200.

The processor 302 is operatively coupled to a communication module 306 such that the server system 300 can communicate with a remote device such as a computing system 200 (shown in FIG. 2) or another server system. For example, the communication module 306 may receive communications from one or more of the computing devices 12 or 14 via the network 22, and/or from one or more of the applications servers 16 via the communication network 24, as illustrated in FIG. 1. The communication module 306 is connectable via wires, such as electrical cables or fiber optic cables, or wirelessly, such as radio frequency (RF) communication. The communication module 306 may include, for example, a wired or wireless network adapter or a wireless data transceiver for use with Bluetooth communication, RF communication, near field communication (NFC), and/or with a mobile phone network, Global System for Mobile communications (GSM), 3G, or other mobile data network, and/or Worldwide Interoperability for Microwave Access (WiMax) and the like.

The processor 302 is operatively coupled to the storage device 310. The storage device 310 is any computer-operated hardware suitable for storing and/or retrieving data. In some embodiments, the storage device 310 is integrated in the server system 300, while in other embodiments, the storage device 310 is external to the server system 300. In the exemplary embodiment, the storage device 310 includes, but is not limited to, the database 20 (shown in FIG. 1). For example, the server system 300 may include one or more hard disk drives as the storage device 310. In other embodiments, the storage device 310 is external to the server system 300 and may be accessed by a plurality of server systems. For example, the storage device 310 may include multiple storage units such as hard disks or solid-state disks in a redundant array of inexpensive disks (RAID) configuration. The storage device 310 may include a storage area network (SAN) and/or a network attached storage (NAS) system.

In some embodiments, the processor 302 is operatively coupled to the storage device 310 via a storage interface 308. The storage interface 308 is any component capable of providing the processor 302 with access to the storage device 310. The storage interface 308 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing the processor 302 with access to the storage device 310.

The memory area 304 includes, but is not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are exemplary only and are thus not limiting as to the types of memory usable for storage of a computer program.

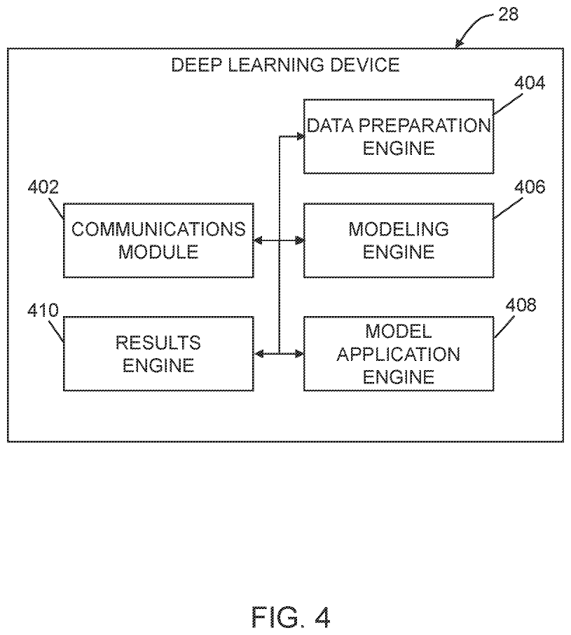

FIG. 4 is a component diagram of the deep learning device 28, according to one aspect of the present invention. In the example embodiment, the deep learning device 28 includes a communications module 402, a data preparation engine 404, a modeling engine 406, a model application engine 408, and a results engine 410 which, together, perform various aspects of the modeling methods described herein. More specifically, the communications module 402 is configured to perform various communication functionality between the deep learning device 28 and other computing devices, such as the application servers 16, the database servers 18, and/or other computing devices of the computing system 10 (i.e., the payment processing system interchange network). For example, the communications module 402 may be configured to receive input data (e.g., from the application servers 16 and/or the database servers 18) for the various inputs used to create the models described herein, or to transmit results of applications of those models (e.g., to the computing devices 12 and/or the application servers 16).

The data preparation engine 404 is configured to extract transaction data (preferably select portions thereof) from the data sources 20, generate one or more tables of prepared data for use in training deep learning models, append various columns and/or identifiers to the prepared data, remove duplicated data, remove outlier data, and/or normalize, transform, or otherwise prepare the data for subsequent use in training the deep learning models. The modeling engine 406 is configured to train deep learning models, using various input data, which can generate predictions of cardholder behavior after the occurrence of certain selected transaction events (e.g., first contactless transaction, mobile transaction, cross-border transaction, declined transactions, card-on-file transactions, etc.). The model application engine 408 applies the models built by the modeling engine 406 to customer transaction data to generate predictions of cardholder behavior (e.g., using aspects of selected cardholder data as inputs to the models). In an example embodiment, the model application engine 408 is illustrated as a part of the deep learning device 28. In other embodiments, the models built by the modeling engine 406 may be deployed to or otherwise accessible from other computing devices in the computing system 10, such as the application servers 16. The results engine 410 generates and presents the output or results of the models to customers (e.g., payment card issuers) through various venues.

### Exemplary Computer-Implemented Methods

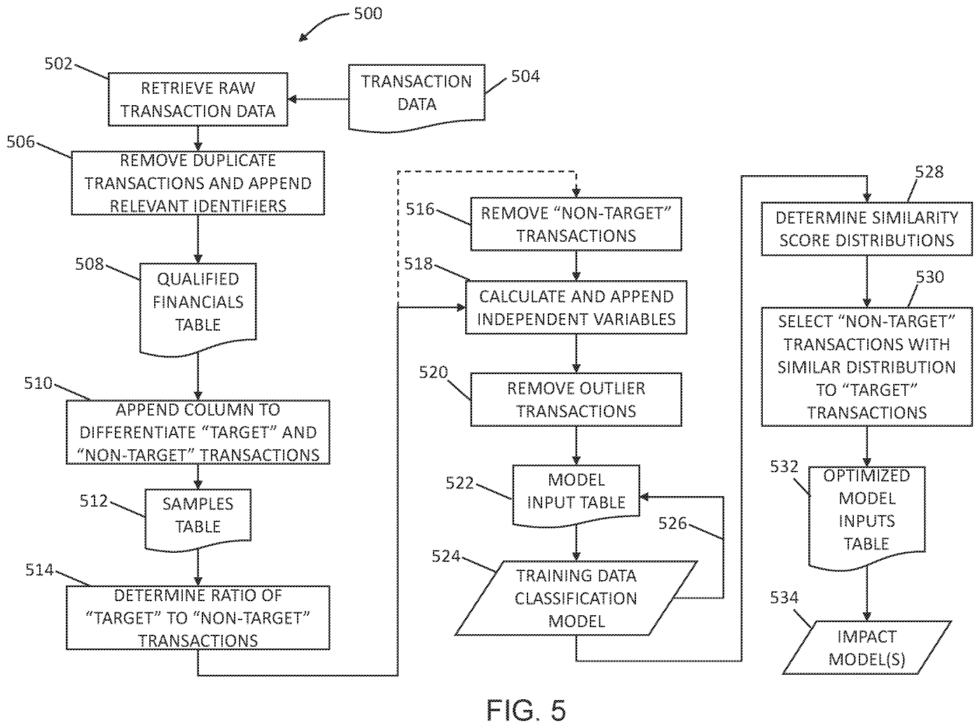

FIG. 5 is a flowchart illustrating an exemplary computer-implemented method 500 of training a neural network to predict the impact of select transaction events on cardholder behavior, according to one aspect of the present invention. The operations described herein may be performed in the order shown in FIG. 5 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 500 is described below, for ease of reference, as being executed by exemplary devices and components introduced with the embodiments illustrated in FIGS. 1-4. In one embodiment, the computer-implemented method 500 is implemented by the deep learning device 28 (shown in FIGS. 1 and 4). In the exemplary embodiment, the computer-implemented method 500 relates to novel techniques for preparing and optimizing training data used to train one or more deep learning models to predict the impact of select transaction events on cardholder behavior. While operations within the computer-implemented method 500 are described below regarding the deep learning device 28, according to some aspects of the present invention, the computer-implemented method 500 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 502, the deep learning device 28 retrieves, via the communications module 402, historical raw transaction data 504, such as a portion of the raw transaction data 26 (shown in FIG. 1), from one or more databases, such as the databases 20 (shown in FIG. 1). In an example embodiment, operation 502 pulls relevant raw transaction data 504 from the databases 20, wherein the relevant raw transaction data 504 may be associated with a selected issuer product, selected issuer, selected issuer segment, and the like. For example, and without limitation, in one embodiment, the retrieved raw transaction data 504 is associated with a single issuer.

The historical raw transaction data 504 preferably spans a predetermined period. In one embodiment, for example, the predetermined period is a rolling thirteen-month period determined from the date the historical raw transaction data 504 is retrieved. Alternatively, the predetermined period can include a full year of historical transaction data, a particular number of years or months of historical transaction data, or any other predetermined period that enables the method 500 to be performed as described herein.

The raw transaction data 504 may be temporarily saved in a data table (not shown) for further manipulation. This operation may be referred to as the initial data load or data extract phase. The data source 20 include databases that are configured to store raw transaction data for transactions that have been cleared and/or declined. In embodiments of the present application, the data source 20 may include, for example, a Global Clearing Management System (GCMS) server, a Global Collection Only (GCO) server, and/or a Mastercard Debit Switch (MDS) server. It will be appreciated by a skilled person in the art that other similar data sources can also be used.

The deep learning device 28, via the data preparation engine 404, performs a series of data enrichment operations to generate enriched training data, as described below. At operation 506, the data preparation engine 404 removes duplicate transactions and appends one or more relevant identifiers to the relevant raw transaction data 504. For example, in one embodiment, the deep learning device 28 may be tasked with identifying mobile payment transactions (by cardholder account) within the raw transaction data 504. In such an embodiment, the data preparation engine 404 may apply a machine-readable query (such as an SQL Script) including one or more selected parameters to the raw transaction data 504. The query may be formatted to append an isMobilePayment column to the temporary data table that includes the raw transaction data 504 and flag the mobile payment transactions with an identifier in the isMobilePayment column. The non-mobile payment transactions may include, for example, a NULL value in the isMobilePayment column. In accordance with one aspect of the present invention, the machine-readable query is in a form required by the deep learning device 28 and/or data source 20 for identifying and flagging the raw transaction data 504. The data source 20 may be implemented using various database software, including, for example, and without limitation, SQL Server, Oracle, DB2, and PostgreSQL. In a preferred embodiment, the data source 20 is implemented as an SQL Server database server. Below is an example machine-readable query in the form required by SQL Server:

isMobilePayment=DE22_CARD_DATA_INPUT_MODE_CD″ IN(‘A’, ‘M’, ‘07’, ‘91’)) AND PDS1 PayPass Acct Nbr Type Ind=C, CC, H, HC

It will be appreciated by a skilled person in the art that other similar machine-readable queries can also be used to flag the raw transaction data 504 with any relevant flag or identifier as desired. At operation 508, the flagged raw transaction data 504 is stored to a data table, such as a “qualified financials” table.

The deep learning device 28, via the data preparation engine 404, then uses as input the qualified financials table. At operation 510, the deep learning device 28, via the data preparation engine 404, appends a column to the qualified financials table to differentiate “target” and “non-target” transactions of the raw transaction data 504. The operation 510 may be performed, for example, via one or more SQL Scripts. As used herein, a “target” transaction includes a transaction that represents an account's first transaction event of interest (e.g., a first contactless transaction, first mobile transaction, first cross-border transaction, declined transactions, card-on-file transactions, etc.). For example, in one aspect of the present invention, a transaction event of interest may include a first contactless transaction. Thus, the first contactless transaction associated with a cardholder account in the raw transaction data 504 will be flagged as a target transactions. A “non-target” transaction includes all other transactions that are not target transactions. At operation 512, the raw transaction data 504 with the “target” and “non-target” transactions identified is stored to a data table, such as a “samples” table.

The deep learning device 28, via the data preparation engine 404, then uses as input, the samples table, for one or more feature engineering operations. For example, at operation 514, the deep learning device 28, via the data preparation engine 404, determines a ratio of the “target” to the “non-target” transactions contained in the samples table. If the ratio is below a predefined threshold value, at operation 516, the data preparation engine 404 removes a number of “non-target” transactions from the samples table until the ratio meets or otherwise exceeds the predefined threshold value. In one aspect of the present invention, the predefined threshold value is in a range between and including about one to four (1:4) and about one to six (1:6). In a preferred embodiment, the predefined threshold value is about one to five (1:5). It is contemplated, however, that the predefined threshold value may be any ratio of target transactions to non-target transactions that enables the deep learning device 28 to function as described herein.

In one embodiment, the data preparation engine 404 removes one or more “non-target” transactions on a random selection basis to achieve the predefined threshold value. Alternatively, the data preparation engine 404 may apply any withdrawal rule that enables the data preparation engine 404 to function as described herein. For example, the data preparation engine 404 may apply a first-in, first-out (FIFO) rule, a last-in, first-out (LIFO) rule, or the like to remove the “non-target” transactions.

Furthermore, at operation 518, the data preparation engine 404 may calculate a plurality of independent variables associated with the raw transaction data 504, and particularly, the “target” transactions, contained in the sample table. The data preparation engine 404 may also append one or more columns to the sample table, each associated with a respective one of the independent variables and insert the independent variable values in each associated column. The independent variables may include, for example, and without limitation, one or more of the following: prior thirty (30) day spend relative to the occurrence of the target transaction; prior ninety (90) day spend relative to the occurrence of the target transaction; prior one hundred and eighty (180) day spend relative to the occurrence of the target transaction; prior year spend relative to the occurrence of the target transaction; number of transactions in the respective prior periods; ninety (90) day spend after the occurrence of the target transaction; total spend amounts per industry based on prior spend periods; and the like. It will be appreciated by a skilled person in the art that other similar independent variables relevant for predicting future cardholder behavior can also be used, based on the target transaction event.

In some embodiments, at operation 520, the data preparation engine 404 identifies and removes one or more outlying transactions by applying one or more outlier detection algorithms (for example, inter quartile range, nearest neighbor outlier, z-score, isolation forest, etc.). After the one or more feature engineering operations are performed, at operation 522, the data preparation engine 404 saves the enriched samples table as a “model inputs” table.

At operation 524, the deep learning device 28, via the modeling engine 406, receives as input the “model inputs” table for use as training data to train a neural network using the “target” transaction event (i.e., “isTarget”) as the dependent variable to generate a training data classification model. The training data classification model is a supervised machine learning model used to provide a “similarity score” for each target/non-target transaction processed by the model. The similarity score provides an indication of how similar a processed transaction is to a target transaction.

At operation 526, the deep learning device 28, via the model application engine 408, applies the training data classification model to the “model inputs” table and determines a similarity score for each respective transaction. At operation 528, the deep learning device 28, via the model application engine 408, determines a first similarity score distribution associated with the target transactions and a second similarity score distribution associated with the non-target transactions. At operation 530, the data preparation engine 404 selects a plurality of non-target transactions whose combined similarity score distribution matches or mirrors, within a predetermined error range, the first similarity score distribution of the target transactions. At operation 532, the data preparation engine 404 saves an “optimized model inputs” table that includes the target transactions from the “model inputs” table and the selected non-target transactions whose combined similarity scores match or mirror the first similarity score distribution of the target transactions. Thus, the “optimized model inputs” table is a subset of the “model inputs” table that includes target and non-target transactions that share a similar “similarity score” distribution. The “optimized model inputs” table includes the training transaction data used to train one or more impact models, as described herein.

At operation 534, the deep learning device 28, via the modeling engine 406, train one or more impact models (e.g., neural networks) using the “model inputs” and “optimized model inputs” tables as input training data. The one or more impact models to be trained (such as neural network algorithms) may be configured to use the training examples provided in the training data (i.e., the “model inputs” or the “optimized model inputs” tables) during a training phase in order to learn how to predict the impact of select transaction events (i.e., target transactions) on cardholder behavior. For example, in regard to mobile payments, the one or more impact models may include the following: a spend(base) model; a spend(projection) model; a propensity(projection) model; a mobile payment spend(base) model; a non-mobile payment spend(base) model; a transaction count(base) model; and a transaction size(base) model.

The spend(base) model may be used to determine an impact on cardholder spending after the occurrence of a first mobile payment. The mobile payment spend(base) model may be used to determine an impact on cardholder spending via mobile payment transactions after the occurrence of the first mobile payment. The non-mobile payment spend(base) model may be used to determine an impact on cardholder spending via non-mobile payment transactions after the occurrence of the first mobile payment. The transaction count(base) model may be used to determine an impact on the number of transactions performed by the cardholder after the occurrence of the first mobile payment. The transaction size(base) model may be used to determine an impact on the size or amount of a typical transaction after the occurrence of the first mobile payment. Each of the *(base) models described above use the “model inputs” table as its training input data. The models are then used to analyze a first set of issuer transactions in which each account represented includes a target transaction (i.e., first mobile payment).

The spend(projection) model may be used to predict cardholder spending if the cardholder were to perform a first mobile payment. The spend(projection) model uses the “model inputs” table as its training input data. The model is then used to analyze a second set of issuer transactions in which each account represented does not include a target transaction (i.e., first mobile payment). The propensity(projection) model may also be used to predict cardholder spending if the cardholder were to perform a first mobile payment. The spend(projection) model uses the “optimized model inputs” table as its training input data. The model is then used to analyze the second set of issuer transactions in which each account represented does not include a target transaction (i.e., first mobile payment).

In a specific example of a neural network, the neural network may be constructed of an input layer and an output layer, with a number of ‘hidden’ layers therebetween. Each of these layers may include a number of distinct nodes. The nodes of the input layer are each connected to the nodes of the first hidden layer. The nodes of the first hidden layer are then connected to the nodes of the following hidden layer or, in the event that there are no further hidden layers, the output layer. However, while, in this specific example, the nodes of the input layer are described as each being connected to the nodes of the first hidden layer, it will be appreciated that the present disclosure is not particularly limited in this regard. Indeed, other types of neural networks may be used in accordance with embodiments of the disclosure as desired depending on the situation to which embodiments of the disclosure are applied.

The nodes of the neural network each take a number of inputs and produce an output based on those inputs. The inputs of each node have individual weights applied to them. The inputs (such as the properties of the accounts) are then processed by the hidden layers using weights, which are adjusted during training. The output layer produces a prediction from the neural network (which varies depending on the input that was provided).

In examples, during training, adjustment of the weights of the nodes of the neural network is achieved through linear regression models. However, in other examples, logistic regression can be used during training. Basically, training of the neural network is achieved by adjusting the weights of the nodes of the neural network in order to identify the weighting factors which, for the training input data provided, produce the best match to the actual data which has been provided.

In other words, during training, both the inputs and target outputs of the neural network may be provided to the model to be trained. The model then processes the inputs and compares the resulting output against the target data (i.e., sets of transaction data from one or more issuers). Differences between the output and the target data are then propagated back through the neural network, causing the neural network to adjust the weights of the respective nodes of the neural network. However, in other examples, training can be achieved without the outputs, using constraints of the system during the optimization process.

Once trained, new input data (i.e., new transaction data from one or more issuers) can then be provided to the input layer of the trained one or more impact models, which will cause the trained one or more impact models to generate (on the basis of the weights applied to each of the nodes of the neural network during training) a predicted output for the given input data (e.g., being a prediction of future spend of an account based on the occurrence of one or more transaction events).

However, it will be appreciated that the neural network described here is not particularly limiting to the present disclosure. More generally, any type of machine learning model or machine learning algorithm can be used in accordance with embodiments of the disclosure.

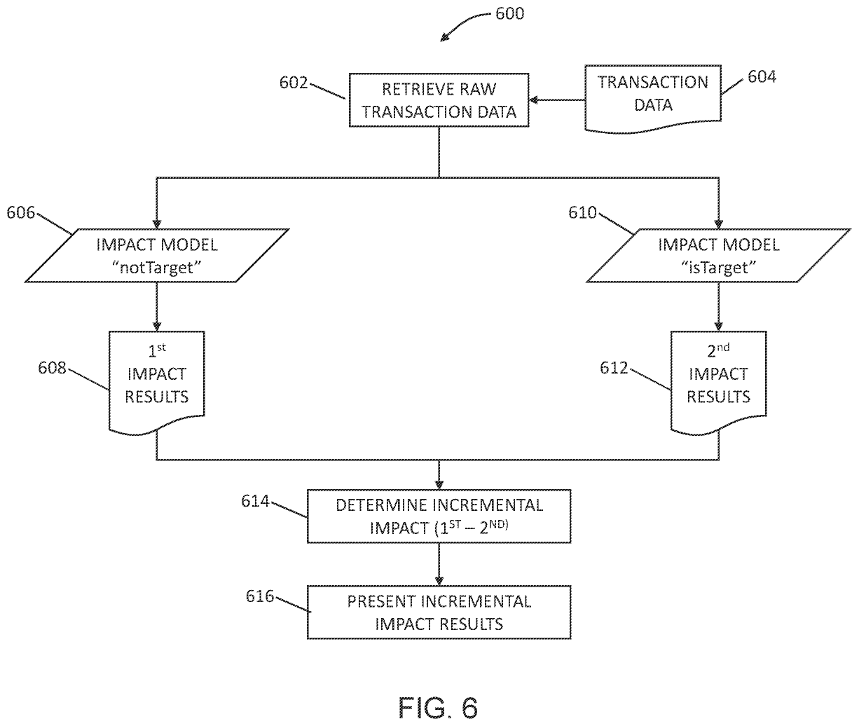

FIG. 6 is a flowchart illustrating an exemplary computer-implemented method 600 of applying deep learning to predict the impact of select transaction events on cardholder behavior, according to one aspect of the present invention. The operations described herein may be performed in the order shown in FIG. 6 or, according to certain inventive aspects, may be performed in a different order. Furthermore, some operations may be performed concurrently as opposed to sequentially, and/or some operations may be optional, unless expressly stated otherwise or as may be readily understood by one of ordinary skill in the art.

The computer-implemented method 600 is described below, for ease of reference, as being executed by exemplary devices and components introduced with the embodiments illustrated in FIGS. 1-4. In one embodiment, the computer-implemented method 600 is implemented by the deep learning device 28 (shown in FIGS. 1 and 4). In the exemplary embodiment, the computer-implemented method 600 relates to novel techniques for applying one or more deep learning models to predict the impact of select transaction events on cardholder behavior. While operations within the computer-implemented method 600 are described below regarding the deep learning device 28, according to some aspects of the present invention, the computer-implemented method 600 may be implemented using any other computing devices and/or systems through the utilization of processors, transceivers, hardware, software, firmware, or combinations thereof. A person having ordinary skill will also appreciate that responsibility for all or some of such actions may be distributed differently among such devices or other computing devices without departing from the spirit of the present disclosure.

One or more computer-readable medium(s) may also be provided. The computer-readable medium(s) may include one or more executable programs stored thereon, wherein the program(s) instruct one or more processors or processing units to perform all or certain of the steps outlined herein. The program(s) stored on the computer-readable medium(s) may instruct the processor or processing units to perform additional, fewer, or alternative actions, including those discussed elsewhere herein.

At operation 602, the deep learning device 28 retrieves, via the communications module 402, a set of customer raw transaction data 604, such as a predetermined portion of the raw transaction data 26 (shown in FIG. 1), from one or more databases, such as the databases 20 (shown in FIG. 1). In an example embodiment, the raw transaction data 604 may be associated with a selected issuer product, selected issuer, selected issuer segment, and the like. In the example embodiment, the raw transaction data 604 is associated with the same selected issuer product, selected issuer, selected issuer segment, etc. as the training data used to train the one or more impact models, as described above.

At operation 606, the deep learning device 28, via the model application engine 408, in a first instance applies one or more of the impact models (e.g., the spend(base) model; the spend(projection) model; the propensity(projection) model, etc.), using one or more independent variables (e.g., prior spend features) and a variable representing a target transaction event (e.g., a first contactless transaction, mobile transaction, cross-border transaction, declined transaction, card-on-file transaction, etc.) to the customer raw transaction data 604 to predict a first result 608 (e.g., a future spend amount). For example, in the first instance, the variable representing the target transaction may be a “notTarget” variable. The impact model, being trained on target and non-target transactions, has “learned” a best function “ƒ” that takes in prior spend features (i.e., the one or more independent variables) plus the target transaction variable and predicts or outputs a future spend of the account. An example wherein the impact of a contactless transaction is the target transaction of interest is indicated below:

ƒ(A, B, C, D, “NotContactless”)=projects $X future spend

At operation 610, the deep learning device 28, via the model application engine 408, in a second instance applies the impact model, the one or more independent variables, and the variable representing a target transaction to the customer raw transaction data 604 to predict a second result 612 (e.g., a future spend amount). For example, in the second instance, the variable representing the target transaction may be an “isTarget” variable. Because the impact model was trained on target and non-target transactions, the model can be used on the same data, but the target transaction variable may be “flipped” (i.e., changed from “notTarget” to “isTarget”) An example wherein the impact of a contactless transaction is the target transaction is indicated below:

ƒ(A, B, C, D, “Contacless”)=projects $Y future spend

At operation 614, the deep learning device 28, via the results engine 410, determines a predicted incremental impact on cardholder behavior. More particularly, the results engine 410 may determine a difference between the results from the first instance model application from the results of the second instance model application (i.e., $X-$Y). Alternatively, the results engine 410 may subtract the second instance results from the first instance results.

At operation 616, the deep learning device 28, via the results engine 410, presents the incremental impact of the target transaction to the issuer computing device operated by an issuer associated with the transaction data 604 through various venues. For example, in one embodiment, the calculated incremental impact may be presented to the issuer computing device, along with other transaction data determined by the application of the one or more impact models, in a report formatted to highlight the incremental impact data.

Example embodiments of systems and methods for training and applying deep learning models to predict the impact of select transaction events on cardholder behavior are described above in detail. Having described aspects of the disclosure in detail, it will be apparent that modifications and variations are possible without departing from the scope of aspects of the disclosure as defined in the appended claims. Because various changes are possible in the above constructions, products, and methods without departing from the scope of aspects of the disclosure, it is intended that all matter contained in the above description and shown in the accompanying drawings shall be interpreted as illustrative and not in a limiting sense.

For example, the methods may also be used in combination with other account systems and methods and are not limited to practice with only the payment systems and methods as described herein. Rather, the example embodiment can be implemented and utilized in connection with many other data storage and analysis applications. While the disclosure has been described in terms of various specific embodiments, those skilled in the art will recognize that particular elements of one drawing in the disclosure may be practiced with elements of other drawings herein, or with modification thereto, and without departing from the spirit or scope of the claims.

### Additional Considerations

All terms used herein are to be broadly interpreted unless otherwise stated. For example, the term “payment card” and the like may, unless otherwise stated, broadly refer to substantially any suitable transaction card, such as a credit card, a debit card, a prepaid card, a charge card, a membership card, a promotional card, a frequent flyer card, an identification card, a prepaid card, a gift card, and/or any other device that may hold payment account information, such as mobile phones, Smartphones, personal digital assistants (PDAs), key fobs, and/or computers. Each type of transaction card can be used as a method of payment for performing a transaction.

As used herein, the term “cardholder” may refer to the owner or rightful possessor of a payment card. As used herein, the term “cardholder account” may refer specifically to a PAN or more generally to an account a cardholder has with the payment card issuer and that the PAN is or was associated with. As used herein, the term “merchant” may refer to a business, a charity, or any other such entity that can generate transactions with a cardholder account through a payment card network.

In this description, references to “one embodiment,” “an embodiment,” or “embodiments” mean that the feature or features being referred to are included in at least one embodiment of the technology. Separate references to “one embodiment,” “an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the current technology can include a variety of combinations and/or integrations of the embodiments described herein.

Although the present application sets forth a detailed description of numerous different embodiments, it should be understood that the legal scope of the description is defined by the words of the claims and equivalent language. The detailed description is to be construed as exemplary only and does not describe every possible embodiment because describing every possible embodiment would be impractical. Numerous alternative embodiments may be implemented, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order recited or illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The foregoing statements in this paragraph shall apply unless so stated in the description and/or except as will be readily apparent to those skilled in the art from the description.

Certain embodiments are described herein as including logic or a number of routines, subroutines, applications, or instructions. These may constitute either software (e.g., code embodied on a machine-readable medium or in a transmission signal) or hardware. In hardware, the routines, etc., are tangible units capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as computer hardware that operates to perform certain operations as described herein.

In various embodiments, computer hardware, such as a processor, may be implemented as special purpose or as general purpose. For example, the processor may comprise dedicated circuitry or logic that is permanently configured, such as an application-specific integrated circuit (ASIC), or indefinitely configured, such as a field-programmable gate array (FPGA), to perform certain operations. The processor may also comprise programmable logic or circuitry (e.g., as encompassed within a general-purpose processor or other programmable processor) that is temporarily configured by software to perform certain operations. It will be appreciated that the decision to implement the processor as special purpose, in dedicated and permanently configured circuitry, or as general purpose (e.g., configured by software) may be driven by cost and time considerations.

Accordingly, the term “processor” or equivalents should be understood to encompass a tangible entity, be that an entity that is physically constructed, permanently configured (e.g., hardwired), or temporarily configured (e.g., programmed) to operate in a certain manner or to perform certain operations described herein. Considering embodiments in which the processor is temporarily configured (e.g., programmed), each of the processors need not be configured or instantiated at any one instance in time. For example, where the processor comprises a general-purpose processor configured using software, the general-purpose processor may be configured as respective different processors at separate times. Software may accordingly configure the processor to constitute a particular hardware configuration at one instance of time and to constitute a different hardware configuration at a different instance of time.

Computer hardware components, such as transceiver elements, memory elements, processors, and the like, may provide information to, and receive information from, other computer hardware components. Accordingly, the described computer hardware components may be regarded as being communicatively coupled. Where multiple of such computer hardware components exist contemporaneously, communications may be achieved through signal transmission (e.g., over appropriate circuits and buses) that connect the computer hardware components. In embodiments in which multiple computer hardware components are configured or instantiated at separate times, communications between such computer hardware components may be achieved, for example, through the storage and retrieval of information in memory structures to which the multiple computer hardware components have access. For example, one computer hardware component may perform an operation and store the output of that operation in a memory device to which it is communicatively coupled. A further computer hardware component may then, at a later time, access the memory device to retrieve and process the stored output. Computer hardware components may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the processors may be located in a specific location (e.g., within a home environment, an office environment or as a server farm), while in other embodiments the processors may be distributed across a number of locations.

Unless specifically stated otherwise, discussions herein using words such as “processing,” “computing,” “calculating,” “determining,” “presenting,” “displaying,” or the like may refer to actions or processes of a machine (e.g., a computer with a processor and other computer hardware components) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

Although the disclosure has been described with reference to the embodiments illustrated in the attached figures, it is noted that equivalents may be employed, and substitutions made herein, without departing from the scope of the disclosure as recited in the claims.

Having thus described various embodiments of the disclosure, what is claimed as new and desired to be protected by Letters Patent includes the following:

1. A system for training and applying deep learning within a payment network to predict an impact of select transaction events on cardholder behavior, the system comprising:
a database storing historical raw transaction data;
a processor; and
a memory storing computer-executable instructions thereon, the computer-executable instructions, when executed by the processor, causing the processor to:
retrieve, via a communications module, the historical raw transaction data, the historical raw transaction data including a plurality of transactions, wherein each transaction is one of a target transaction or a non-target transaction;
enrich, via a data preparation engine, the historical raw transaction data by appending a target transaction identifier to each of the target transactions contained in the historical raw transaction data, the target transactions being related to a predetermined target transaction event;
store the enriched historical raw transaction data to a first data table;
train, via a modeling engine, a first neural network using the first data table with the target transaction event as a dependent variable to generate a training data classification model;
apply, via a model application engine, the training data classification model to the first data table;
determine, via the model application engine, a first similarity score distribution associated with the target transactions and a second similarity score distribution associated with the non-target transactions;
select, via the data preparation engine, a plurality of non-target transactions whose combined similarity score distribution matches the first similarity score distribution of the target transactions;
based on the selection, store the target transactions and the selected plurality of non-target transactions to a second data table; and
train, via the modeling engine, a second neural network using the second data table.

2. The system in accordance with claim 1,
said enrichment operation further comprising:
calculating one or more independent variables for each transaction of the historical raw transaction data; and
appending the calculated one or more independent variables to each of the transactions contained in the historical raw transaction data.

3. The system in accordance with claim 1,
said computer-executable instructions further causing the processor to:
remove, via the data preparation engine, one or more duplicate transactions from the historical raw transaction data; and
append one or more relevant identifiers to one or more of the plurality of transactions.

4. The system in accordance with claim 1,
said computer-executable instructions further causing the processor to determine a ratio of target transactions to non-target transactions contained in the historical raw transaction data.

5. The system in accordance with claim 4,
said computer-executable instructions further causing the processor to remove one or more non-target transactions from the historical raw transaction data when the ratio of target transactions to non-target transactions is below a predefined threshold value, the removing occurring until the ratio meets or exceeds the predefined threshold value.

6. The system in accordance with claim 5, wherein the predefined threshold value is in a range between and including about one to four (1:4) and about one to six (1:6).

7. The system in accordance with claim 1,
said computer-executable instructions further causing the processor to identify and remove one or more outlying transactions from the historical raw transaction data by applying one or more outlier detection algorithms.

8. A computer-implemented method comprising:
retrieving, via a communications module, historical raw transaction data from a database, the historical raw transaction data including a plurality of transactions, wherein each transaction is one of a target transaction or a non-target transaction;
enriching, via a data preparation engine, the historical raw transaction data by appending a target transaction identifier to each of the target transactions contained in the historical raw transaction data, the target transactions being related to a predetermined target transaction event;
storing, in the database, the enriched first portion of the historical raw transaction data to a first data table;
training, via a modeling engine, a first neural network using the first data table with the target transaction event as a dependent variable to generate a training data classification model;
applying, via a model application engine, the training data classification model to the first data table;
determining, via the model application engine, a first similarity score distribution associated with the target transactions and a second similarity score distribution associated with the non-target transactions;
selecting, via the data preparation engine, a plurality of non-target transactions whose combined similarity score distribution matches the first similarity score distribution of the target transactions;
based on the selection, storing the target transactions and the selected plurality of non-target transactions to a second data table; and
training, via the modeling engine, a second neural network using the second data table.

9. The computer-implemented method in accordance with claim 8,
said enrichment operation further comprising:
calculating one or more independent variables for each transaction of the historical raw transaction data; and
appending the calculated one or more independent variables to each of the transactions contained in the historical raw transaction data.

10. The computer-implemented method in accordance with claim 8, further comprising:
removing, via the data preparation engine, one or more duplicate transactions from the historical raw transaction data; and
appending one or more relevant identifiers to one or more of the plurality of transactions.

11. The computer-implemented method in accordance with claim 8, further comprising determining a ratio of target transactions to non-target transactions contained in the historical raw transaction data.

12. The computer-implemented method in accordance with claim 11, further comprising removing one or more non-target transactions from the historical raw transaction data when the ratio of target transactions to non-target transactions is below a predefined threshold value, the removing occurring until the ratio meets or exceeds the predefined threshold value.

13. The computer-implemented method in accordance with claim 12, wherein the predefined threshold value is in a range between and including about one to four (1:4) and about one to six (1:6).

14. The computer-implemented method in accordance with claim 8, further comprising identifying and removing one or more outlying transactions from the historical raw transaction data by applying one or more outlier detection algorithms.

15. A computer-readable storage medium having computer-executable instructions stored thereon, the computer-executable instructions, when executed by a processor, causing the processor to:
retrieve, via a communications module, a first portion of historical raw transaction data, the first portion of historical raw transaction data including a plurality of transactions, wherein each transaction is one of a target transaction or a non-target transaction;
enrich, via a data preparation engine, the first portion of historical raw transaction data by appending a target transaction identifier to each of the target transactions contained in the first portion of historical raw transaction data, the target transactions being related to a predetermined target transaction event;
store the enriched first portion of historical raw transaction data to a first data table;
train, via a modeling engine, a first neural network using the first data table with the target transaction event as a dependent variable to generate a training data classification model;
apply, via a model application engine, the training data classification model to the first data table;
determine, via the model application engine, a first similarity score distribution associated with the target transactions and a second similarity score distribution associated with the non-target transactions;
select, via the data preparation engine, a plurality of non-target transactions whose combined similarity score distribution matches the first similarity score distribution of the target transactions;
based on the selection, store the target transactions and the selected plurality of non-target transactions to a second data table; and
train, via the modeling engine, a second neural network using the second data table.

16. The computer-readable storage medium in accordance with claim 15,
said enrichment operation further comprising:
calculating one or more independent variables for each transaction of the first portion of historical raw transaction data; and
appending the calculated one or more independent variables to each of the transactions contained in the first portion of historical raw transaction data.

17. The computer-readable storage medium in accordance with claim 15,
said computer-executable instructions further causing the processor to:
remove, via the data preparation engine, one or more duplicate transactions from the first portion of historical raw transaction data; and
append one or more relevant identifiers to one or more of the plurality of transactions.

18. The computer-readable storage medium in accordance with claim 15,
said computer-executable instructions further causing the processor to determine a ratio of target transactions to non-target transactions contained in the first portion of historical raw transaction data.

19. The computer-readable storage medium in accordance with claim 18,
said the computer-executable instructions further causing the processor to remove one or more non-target transactions from the first portion of historical raw transaction data when the ratio of target transactions to non-target transactions is below a predefined threshold value, the removing occurring until the ratio meets or exceeds the predefined threshold value.

20. The computer-readable storage medium in accordance with claim 15,
said computer-executable instructions further causing the processor to identify and remove one or more outlying transactions from the first portion of historical raw transaction data by applying one or more outlier detection algorithms.
